(19) United States
(12) Patent Application Publication
(10) Pub. No.: US 2002/0062562 A1
(43) Pub. Date: May 30, 2002

(54) Method of spin forming oblique end cones of a catalytic converter

(76) Inventors: Houliang Li, Novi, MI (US); Earl Nelson, Livonia, MI (US); Joseph M. Lanzesira, Monroe, MI (US)

Correspondence Address: Steven L. Oberholtzer, BRINKS HOFER GILSOn & LIONE, P.O. Box 10395, Chicago, IL, 60610, US

(21) Appl. No.: 09/993,251

(22) Filed: Nov. 19, 2001

Related U.S. Application Data
(60) Provisional application No. 60/253,166, filed on Nov. 27, 2000.

(51) Int. Cl. C01B 3/00; B01J 8/00; B01D 47/00; B01D 53/34; B21D 51/16

(52) U.S. Cl. 29/890; 423/212

(57) ABSTRACT

The present invention is generally directed towards a catalytic converter installed in the motor vehicles. More specifically to a method of forming the end portion of the catalytic converter using the spinform technique. The catalytic converter defines a central axis and is rotated around the central axis. At least one roller is placed perpendicular to the central axis. The roller moves in a transverse direction with respect to the central axis such that the axis of the end portion is at an angle with respect to the central axis.

### PRIORITY CLAIM

This application claims priority to U.S. Provisional Application, Serial No. 60/253,166 filed Nov. 27, 2000.

### TECHNICAL FIELD OF THE INVENTION

This invention relates to a catalytic converter installed in a motor vehicle. More specifically, this invention relates to a method of spin forming the oblique end cones of catalytic converters.

### BACKGROUND OF THE INVENTION

Automotive vehicles use catalytic converters to reduce emissions. Catalytic converters occupy various position in the vehicles, some of which require the exhaust inlet and the outlet tubes to be positioned in specific angles with respect to the catalytic convertor body.

One of the preferred way of assembling a catalytic converter is to form the external shell out of a single piece of steel tube. By varying the diameter of the of the tube from narrow to wide and then narrow, a converter body is formed.

One of the techniques know to form catalytic converters is a spinform techniques. Traditionally, spinform techniques have been used to form concentric end portions. One of the process of forming oblique end portion of the catalytic converter is specifically disclosed in U.S. Pat. No. 6,067,833 and is shown in FIG. 1 as prior art.

As disclosed in the prior art patent, the catalytic converter 120 defines a central axis 122, a roller 126 is used to form the oblique end cones 124. In order to form the oblique end portion 124, the roller 126 must position itself at various angles with respect to the central axis 122 of the catalytic converter 120. Typically manufacturing such machines, which have rollers capable of rotating with respect to the catalytic converter, is very expensive and typically increases the cycle time to manufacture the catalytic converter.

Therefore, there is a need in the industry to develop a process where the rollers do not rotate around the body of the catalytic convertor to form the oblique end portions. There is also a need in the industry to design a machine that has shorter cycle times to manufacture the catalytic convertor.

### SUMMARY OF THE INVENTION

In accordance with the teachings of the present invention a catalytic convertor is formed using the spinform techniques. In particular the invention provides for a method of forming an oblique end portion of the catalytic converter. In one aspect of the invention, the catalytic converter defines a central axis. At least one roller is positioned such that the axis of the roller is parallel to the central axis of the catalytic converter. The catalytic converter is capable of spinning around the central axis. The end portions are formed by moving the roller in a transverse direction with respect to the central axis and also in a parallel direction with respect to the central axis.

In another aspect of the invention, the roller forms the end portion of the catalytic converter such that the axis of the end portion is at an angle with respect to the central axis.

### BRIEF DESCRIPTION OF THE DRAWINGS

Further features of the invention will become apparent from the following discussion and the accompanying drawings in which:

FIG. 1 is a cross sectional view of a catalytic converter formed using prior art techniques;

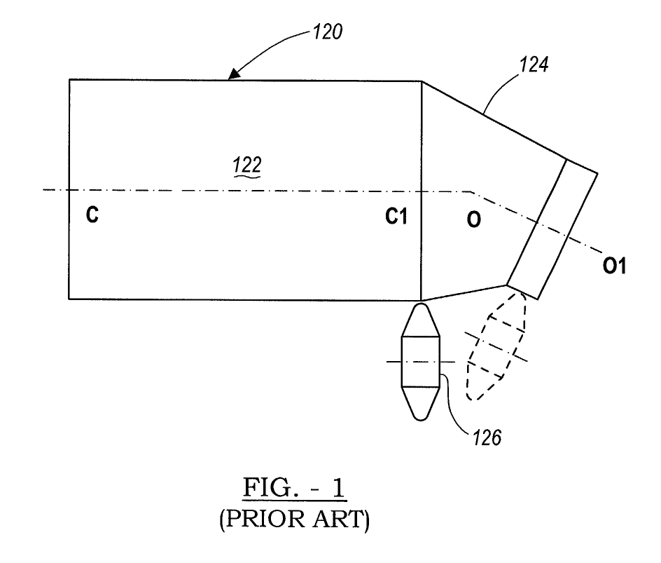

FIG. 2 is a cross sectional view of the catalytic converter having a substrate formed in accordance with the teachings of the present invention; and

FIG. 3 is a cross sectional view of the catalytic converter having oblique end cones formed in accordance with the teachings of the present invention.

### DETAILED DESCRIPTION OF THE PREFERRED EMBODIMENT

The following description of the preferred embodiment is merely exemplary in nature and is in no way intended to limit the invention or its application or uses.

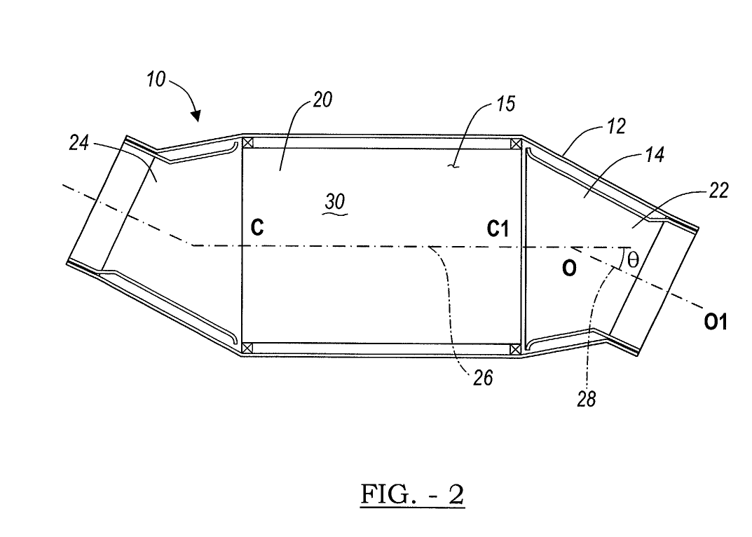

Referring in particular to the FIG. 2, a catalytic converter to be installed in an exhaust system of a motor vehicle is generally illustrated by reference numeral 10. Although not shown in the drawings the catalytic converter 10 is typically installed in the under body of a vehicle and forms a part of the vehicle exhaust system. Alternatively, it may be installed in any other suitable place in the vehicle to typically convert the noxious emissions emitted from the engine.

The catalytic converter 10 comprises an outer housing 12 and an inner housing 14. Although not shown in the drawings, typically one end of the inner housing 14 is connected a conduit for receiving exhaust gasses from the engine. The other end of the inner housing 14 is connected is connected to a exhaust pipe that emits gases that have been converted by the catalytic converter 10. The inner housing 14 defines a hollow interior 15.

The outer housing 12 and the inner housing 14 preferably include a central portion 20 and two end portions 22 and 24 connected on either side of the central portion 20. The central portion 20 defines a central axis C-C1, that is represented by reference numeral 26. The end portions 22 and 24 also define an axis O-O1, represented by reference numeral 28. The axis 28 is at an angle (θ) with respect to the central axis 26. Typically, the angle (θ) between the axis 26 and the axis 28 is between 30° to 60°. The catalytic converter also defines a vertical axis 25. The central portion is preferably symmetrical around the central axis 26 and the vertical axis 25. Alternatively, the cross section of the central portion 20 can be round, ellipse or oval. Preferably, the end portions 22 and 24 are oblique cone-shaped. Throughout this applications the end portions may also be referred to as oblique end portions 22 and 24. The end portions 22 and 24 define an end part 16 (A-A1),that is at an angle with respect to the vertical axis 25.

The catalytic converter 10 in accordance with the teachings of the present invention also includes a catalytic substrate 30 inserted into the hollow interior 15 of the inner housing 14. The catalytic substrate 30 is present in the central portion 20 of the inner housing 14. The catalytic substrate 30 used in the present invention is commercially available from Corning, Inc. and is a ceramic composite brick with the suitable catalyst coated on the ceramic brick.

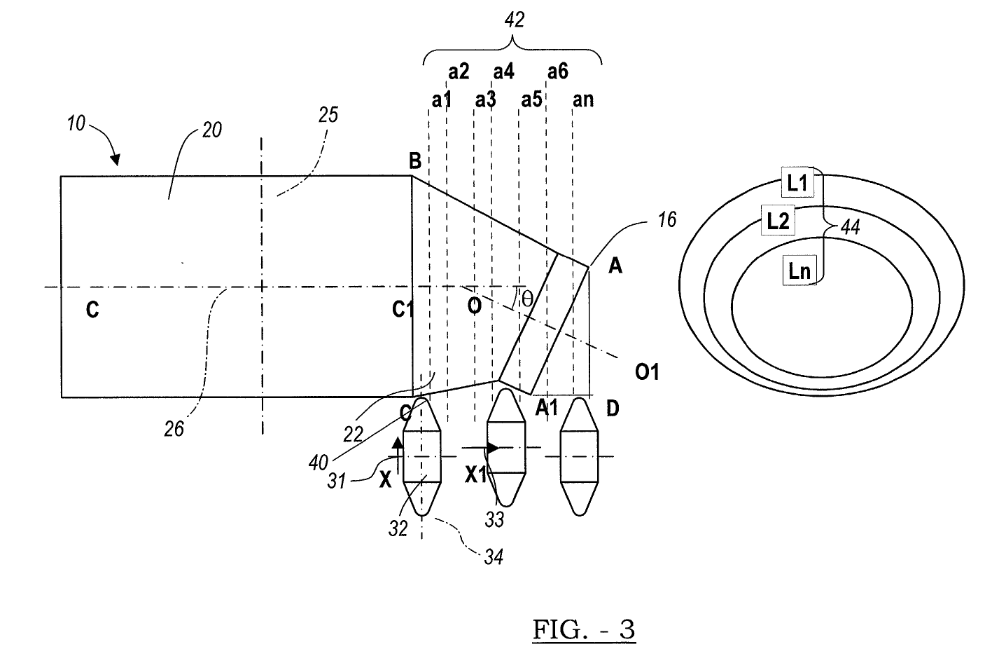

As shown in FIG. 3, a method for assembling the end portions 22 and 24 of the catalytic converter 10 in accordance with the teachings of the present invention is illustrated. In this FIGURE only one end portion 22 is shown and the method of manufacturing the end portion 22 is illustrated. The second end portion 24 can also be manufactured using the method described below.

Although not shown in the drawings, in order to form the end portion 22 a spinning machine is used. The spinning machine includes a mandrel or a shaft (not shown). The catalytic converter 10 is horizontally mounted on the mandrel such that the catalytic converter 10 is capable of rotating around the central axis 26. In order to form the end portion 22, the spinning machine includes at least one roller 32. Although in this drawing only one roller 32 is shown and described it must be understood that more than one roller may be used. The roller 32 used in the present invention is well known in the art and is not explained in details.

The roller 32 defines an axis X-X1 represented by reference numeral 34. The roller 32 is capable of spinning around the axis 34. The roller 32 is placed perpendicular to the central axis 26 and is connected to a control unit such as a computer (not shown) that is programmed to direct the roller 32 in a desired direction. The roller 32 is in contact with a surface 40 of the catalytic converter 10 such that as the roller moves in a desired direction, where the diameter of the catalytic converter 10 is reduced at surface 40. The roller 32 is mounted on actuators (not shown) that move the roller 32 in a direction transverse to the central axis 26 such that the roller 32 is moving towards the central axis 26 as shown by arrow 31. In addition, the roller 32 is also capable of moving in a direction parallel to the central axis 26 as shown by the arrow 33 such that the roller moves the entire end portion 22 of the catalytic converter 10.

In order to determine the path of the roller 32 such that the end portion 22 having an axis 28 at an angle to the central axis 26 is formed, the desired shape of the catalytic converter 10 is designed using Computed Aided Engineering Design Tools. Use of such tools is well know in the art and is not explained in details. The end portion 22 is divided into a number of virtual planes a1, a2, a3 . . . an, collectively represented by reference numeral 42 such that the virtual planes 42 are perpendicular to the central axis 26. A series of contours designated by L1, L2, L3 . . . Ln, collectively represented by reference numeral 44 are formed corresponding to the virtual planes 42. After defining the contours 44, the roller 32 is programmed by the computer to move in a transverse direction 31 and parallel direction 33 to the central axis 26 to follow the contours 44 such that an axis 28 with an angle (θ) with respect to the central axis 26 is formed. Preferably the angle (θ) between the axis 26 and the axis 28 is in the range of 30° to 60°. to the central axis 26.

The end portion 22 has a shape defined by portion ABCD. In order to obtain the desired shape such that the end part 16 A-A1 of the end portion 22 is at an angle with respect to the vertical axis 25, the end part 16 is cut along lines A-A1. Traditional cutting techniques such as laser cutting techniques may be used. It is also possible to use any other well-known techniques such as heat welding etc.

As seen above, the oblique end portions 22 of the catalytic converter 10 is formed without rotating both the catalytic converter 10 and roller 32 relative to each other. Further, the roller 32 is always maintained perpendicular to the central axis 26. In addition the end portion 22 is formed with the use of one roller 32 capable of moving in both a transverse direction 31 and parallel direction 33 with respect to the central axis 26.

As any person skilled in the art will recognize from the previous description and from the figures and claims, modifications and changes can be made to the preferred embodiment of the invention without departing from the scope of the invention as defined in the following claims.

What is claimed is:

1. A method of forming a catalytic converter, the method comprising:
providing a catalytic converter having a central portion and an end portion, wherein the central portion defines a horizontal central axis;
rotating the catalytic converter around the central axis;
placing a roller perpendicular to the central axis;
keeping the roller perpendicular to the central axis;
and forming the end portion by moving the roller in a transverse direction with respect to the central axis.

2. The method of claim 1, further comprising the step of moving the roller in a parallel direction with respect to the central axis.

3. The method of claim 1, wherein the end portion defines an axis at an angle with respect to the central axis of the catalytic converter.

4. The method of claim 3, wherein the angle between the axis of the end portion and the central axis is in the range of 30° to 60°.

5. The method of claim 1, wherein moving the roller in a transverse direction with respect to the central comprises:
dividing the end portion into multiple imaginary planes perpendicular to the central axis;
forming a contour corresponding to the multiple imaginary planes; and
programming the roller to follow the contour.

6. The method of claim 1, further comprising rotating the roller around an axis parallel to the central axis.

7. The method of claim 1, wherein the step of placing the roller comprises the step of contacting a surface of the catalytic converter such that moving the roller in the transverse direction reduces the diameter of the catalytic converter at the surface.

8. The method of claim 1, wherein forming the end portion further comprises cutting an end part of the end portion such that the end part is angled with respect to a vertical axis of the catalytic converter.

9. A method of forming an end portion of a catalytic converter, the method comprising:
providing a catalytic converter having a central portion and an end portion such that the central portion defines a horizontal central axis;
rotating the catalytic converter around the central axis;
placing a roller perpendicular to the central axis;
keeping the roller perpendicular to the central axis; and
moving the roller in a transverse direction with respect to the central axis, wherein the end portion defines an axis at an angle with respect to the central axis.

10. The method of claim 9, further comprising the step of moving the roller in a parallel direction with respect to the central axis.

11. The method of claim 9, wherein the angle between the axis of the end portion and the central axis is in the range of 30° to 60°.

12. The method of claim 9, wherein moving the roller in a transverse direction with respect to the central comprises:
dividing the end portion into multiple imaginary planes perpendicular to the central axis;
forming a contour corresponding to the multiple imaginary planes; and
programming the roller to follow the contour.

13. The method of claim 9, rotating the roller around an axis perpendicular to the central axis.

14. The method of claim 9, wherein the step of placing the roller comprises contacting a surface of the catalytic converter such that moving the roller in the transverse direction reduces the diameter of the catalytic converter at the surface.

15. The method of claim 9, wherein forming the end portion further comprises cutting an end part of said end portion such that the end part is angled with respect to a vertical axis of the catalytic converter.

16. A method of forming an oblique end portion of a catalytic converter, the method comprising:
providing a catalytic converter having a central portion and an end portion such that the central portion defines a horizontal central axis;
rotating the catalytic converter around the central axis;
placing one roller perpendicular to the central axis such that the roller contacts a surface of the end portion;
keeping the roller perpendicular to the central axis;
moving the roller in a transverse direction with respect to the central axis;
moving the roller in a transverse direction with respect to the central axis, such that the end portion defines an axis at an angle with respect to the central axis; and
reducing the diameter of the end portion in the surface .

17. The method of claim 16, wherein the angle between the axis of the end portion and the central axis is in the range of 30° to 60°.

18. The method of claim 16, wherein moving the at least one roller in a transverse direction with respect to the central comprises:
dividing the end portion into multiple imaginary planes perpendicular to the central axis;
forming a contour corresponding to the multiple imaginary planes; and
programming the roller to follow the contour.

19. The method of claim 16, rotating the roller around an axis perpendicular to the central axis.

20. The method of claim 16, wherein forming the end portion further comprises cutting an end part of the end portion such that the end part is angled with respect to a vertical axis of the catalytic converter.
